(19) United States
(12) Patent Application Publication
(10) Pub. No.: US 2025/0300931 A1
(43) Pub. Date: Sep. 25, 2025

(54) SYSTEMS AND METHODS TO ADDRESS CONGESTION IN AN ETHERNET STORAGE AREA NETWORK

(71) Applicant: DELL PRODUCTS L.P., Round Rock, TX (US)

(72) Inventors: Claudio DESANTI, Santa Cruz, CA (US); James SALVADORE, Amherst, NH (US); Erik SMITH, Douglas, MA (US); Arieh DON, Newton, MA (US)

(73) Assignee: DELL PRODUCTS L.P., Round Rock, TX (US)

(21) Appl. No.: 18/613,054

(22) Filed: Mar. 21, 2024

(51) Int. Cl. H04L 47/11; H04L 47/122; H04L 67/1097

(52) U.S. Cl. CPC H04L 47/11; H04L 47/122; H04L 67/1097

(57) ABSTRACT

Embodiments herein allow for endpoints, such as a storage array or a host system, to obtain the speed of a corresponding endpoint that is connected to a port or ports of the endpoint. Given port speeds, an endpoint system may adjust the bandwidth of a payload being sent to the corresponding endpoint system to match the connected port's speed. For example, limiting the data being sent from a storage endpoint system to a host endpoint system in cases where the storage array's port is faster than the host adapter helps mitigate or even ensure that the host adapter of the host endpoint system is not overloaded—thereby avoiding congestion. In one or more embodiments, a centralized discovery controller (CDC) may be enhanced to obtain the current operating speed of a port of an endpoint system.

### BACKGROUND

### A. Technical Field

The present disclosure relates generally to information handling systems. More particularly, the present disclosure relates to reducing network congestion in Ethernet storage area networks (SANs).

### B. Background

The subject matter discussed in the background section shall not be assumed to be prior art merely as a result of its mention in this background section. Similarly, a problem mentioned in the background section or associated with the subject matter of the background section should not be assumed to have been previously recognized in the prior art. The subject matter in the background section merely represents different approaches, which in and of themselves may also be inventions.

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use, such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Currently, no in-band mechanisms exist to obtain, in a storage array (which may also be referred to as a storage subsystem or an endpoint), the speed of an Ethernet port serving as a host. Because the storage array may be sending data at a rate much faster than the host can receive, network traffic may become congested resulting in delays and degradation of service. The same is true for data flows in the opposite direction from host to storage array.

Accordingly, it is highly desirable to find new ways to address potential congestion in networks.

### BRIEF DESCRIPTION OF THE DRAWINGS

References will be made to embodiments of the disclosure, examples of which may be illustrated in the accompanying figures. These figures are intended to be illustrative, not limiting. Although the accompanying disclosure is generally described in the context of these embodiments, it should be understood that it is not intended to limit the scope of the disclosure to these particular embodiments. Items in the figures may not be to scale.

FIG. 1 depicts an Ethernet storage area network (SAN) environment, according to embodiments of the present disclosure.

FIG. 2 depicts a general methodology for mitigating congestion by controlling port speed, according to embodiments of the present disclosure.

FIG. 3 depicts a methodology for mitigating congestion by controlling port speed, according to embodiments of the present disclosure.

FIG. 4 depicts an alternative methodology for mitigating congestion by controlling port speed, according to embodiments of the present disclosure.

FIG. 5 depicts another alternative methodology for mitigating congestion by controlling port speed, according to embodiments of the present disclosure.

FIG. 6 depicts yet another alternative methodology for mitigating congestion by controlling port speed, according to embodiments of the present disclosure.

FIG. 7 depicts a simplified block diagram of an information handling system, according to embodiments of the present disclosure.

FIG. 8 depicts an alternative block diagram of an information handling system, according to embodiments of the present disclosure.

### DETAILED DESCRIPTION OF EMBODIMENTS

In the following description, for purposes of explanation, specific details are set forth in order to provide an understanding of the disclosure. It will be apparent, however, to one skilled in the art that the disclosure can be practiced without these details. Furthermore, one skilled in the art will recognize that embodiments of the present disclosure, described below, may be implemented in a variety of ways, such as a process, an apparatus, a system/device, or a method on a tangible computer-readable medium.

Components, or modules, shown in diagrams are illustrative of exemplary embodiments of the disclosure and are meant to avoid obscuring the disclosure. It shall be understood that throughout this discussion that components may be described as separate functional units, which may comprise sub-units, but those skilled in the art will recognize that various components, or portions thereof, may be divided into separate components or may be integrated together, including, for example, being in a single system or component. It should be noted that functions or operations discussed herein may be implemented as components. Components may be implemented in software, hardware, or a combination thereof.

Furthermore, connections between components or systems within the figures are not intended to be limited to direct connections. Rather, data between these components may be modified, re-formatted, or otherwise changed by intermediary components. Also, additional or fewer connections may be used. It shall also be noted that the terms “coupled,” “connected,” “communicatively coupled,” “interfacing,” “interface,” or any of their derivatives shall be understood to include direct connections, indirect connections through one or more intermediary devices, and wireless connections. It shall also be noted that any communication, such as a signal, response, reply, acknowledgement, message, query, etc., may comprise one or more exchanges of information.

Reference in the specification to “one or more embodiments,” “preferred embodiment,” “an embodiment,” “embodiments,” or the like means that a particular feature, structure, characteristic, or function described in connection with the embodiment is included in at least one embodiment of the disclosure and may be in more than one embodiment. Also, the appearances of the above-noted phrases in various places in the specification are not necessarily all referring to the same embodiment or embodiments.

The use of certain terms in various places in the specification is for illustration and should not be construed as limiting. The terms “include,” “including,” “comprise,” “comprising,” and any of their variants shall be understood to be open terms, and any examples or lists of items are provided by way of illustration and shall not be used to limit the scope of this disclosure.

A service, function, or resource is not limited to a single service, function, or resource; usage of these terms may refer to a grouping of related services, functions, or resources, which may be distributed or aggregated. The use of memory, database, information base, data store, tables, hardware, cache, and the like may be used herein to refer to system component or components into which information may be entered or otherwise recorded. The terms “data,” “information,” along with similar terms, may be replaced by other terminologies referring to a group of one or more bits, and may be used interchangeably. The terms “packet” or “frame” shall be understood to mean a group of one or more bits. The term “frame” shall not be interpreted as limiting embodiments of the present invention to Layer 2 networks; and, the term “packet” shall not be interpreted as limiting embodiments of the present invention to Layer 3 networks. The terms “packet,” “frame,” “data,” or “data traffic” may be replaced by other terminologies referring to a group of bits, such as “datagram” or “cell.” The words “optimal,” “optimize,” “optimization,” and the like refer to an improvement of an outcome or a process and do not require that the specified outcome or process has achieved an “optimal” or peak state.

It shall be noted that: (1) certain steps may optionally be performed; (2) steps may not be limited to the specific order set forth herein; (3) certain steps may be performed in different orders; and (4) certain steps may be done concurrently.

Any headings used herein are for organizational purposes only and shall not be used to limit the scope of the description or the claims. Each reference/document mentioned in this patent document is incorporated by reference herein in its entirety.

It shall also be noted that although embodiments described herein may be within the context of Ethernet SANs, aspects of the present disclosure are not so limited. Accordingly, the aspects of the present disclosure may be applied or adapted for use in other contexts.

### A. General Introduction

In Fibre Channel (FC) networks, the FC connectivity provides a mechanism by which a storage array may detect a host adapter's (or, a host) current operating speed. For example, the speed of an F_Port (i.e., the switch port to which the host adapter is attached) may be obtained by using a combination of GFPN_ID and GPSC. GFPN_ID stands for “Get Fabric Port Name for the specified ID.” The requestor (e.g., a storage port) may send a GFPN_ID to an FC fabric service. The request includes the ID (e.g., a 24-bit address) of the host, and the response from the FC service contains a Fabric Name (e.g., a 64-bit world-wide unique name (WWN)) of the switch port where the 24-bit ID is currently attached. The WWN of the switch port is used with GPSC. GPSC stands for “Get Port Speed Capabilities.” The requestor (e.g., a storage port) may send a GPSC to an FC fabric service. The request includes the Fabric Name of the switch port where the host is attached (retrieved using GFPN_ID). The response may include the speeds that can be supported by the fabric port as well as the current operating speed of that fabric port. Because FC links always negotiate the same speed in both directions (transmit (TX) and receive (RX)), the current operating speed of the switch port may be used to determine the current operating speed of the host.

In contrast, unlike FC, there is no in-band equivalent in Ethernet networks. However, Ethernet SANs are quite prevalent. In addition, Ethernet SANs can be very large, which makes managing congestion important for good network performance.

Currently, with Ethernet networks, both priority flow control (PFC) and explicit congestion notification (ECN) may be used together to detect and attempt to remediate causes of congestion. However, both PFC and ECN require tuning to be performed, and the tuning parameters are typically very heavily dependent on the network topology in use. If these parameters are not properly tuned, either link utilization will be lower than necessary (e.g., wastes bandwidth resources) or higher than can be supported by a receiver, which will likely cause frames to be dropped and the transmitter to decrease its congestion window (e.g., decrease it by half) and leads to spikes in latency and drops in throughput. In large environments, such as in APEX cloud environments that can involve integrating infrastructure, automated management and operations software, and cloud operating stacks to deliver consistent multi-cloud operations by extending cloud operating environments to on-premises data center and edge locations, such tuning is extremely difficult due to the size of the Ethernet networks deployed. In such large-size networks, automated congestion control would be extremely beneficial to allow all components to perform well.

Accordingly, embodiments herein allow for endpoints, such as a storage array or host system, to obtain the speed of a corresponding endpoint that is connected to a port or ports of the endpoint. Given port speeds, an endpoint system can adjust the amount of bandwidth consumed to send a payload to the corresponding receiving endpoint system on a port to match the connected adapter speed. For example, limiting the data being sent from a storage endpoint system to a host endpoint system in cases where the storage array's port is faster than the host adapter helps mitigate or even ensure that the host adapter of the host endpoint system is not overloaded—thereby avoiding congestion. In one or more embodiments, a centralized discovery controller (CDC) may be enhanced to obtain the current operating speed of a port of an endpoint system via an interface (e.g., a management interface of a network information handling system (e.g., a switch)) or reporting mechanisms.

In one or more embodiments, once an array has the host adapter speed, for each host adapter connected to the storage array ports, the storage array can limit the bandwidth consumed to send data to the host adapter (e.g., limit to the speed at which the host adapter is communicating). Such embodiments help to reduce the occurrence of congestion in the Ethernet SAN, and for most cases in which a host communicates with a single storage array, embodiments may prevent congestion from occurring.

### B. System and Method Embodiments

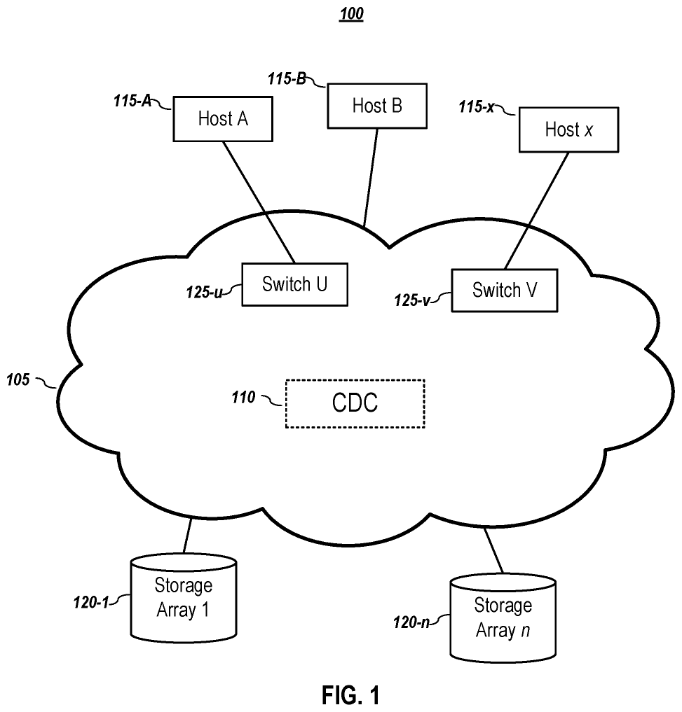

FIG. 1 depicts an Ethernet storage area network (SAN) environment, according to embodiments of the present disclosure. Depicted is an Ethernet SAN environment 100 that includes a centralized discovery controller (CDC) 110 (which may also be referred to as a root discovery controller) within an Ethernet fabric 105. The CDC 110 may operate on a single information handling system or may be distributed to a set of information handling systems. For example, in one or more embodiments, different CDC services may be distributed across different information handling system within the fabric 105.

In the depicted embodiment there are a plurality of host systems, host A 115-A, host B 115-B, and host x 115-x, and there is a plurality of storage subsystems (e.g., storage array 1 120-1 and storage array n 120-n). The host systems and storage subsystems may also be referred to as endpoints or endpoint systems. In one or more embodiments, one or more of the endpoints may be nonvolatile memory express (NVMe) entities. NVMe is a protocol designed for accessing storage media connected through a bus (e.g., via a PCIe (Peripheral Component Interconnect Express) bus).

In one or more embodiments, the endpoints may register with the CDC, which may be performed as part of a registration process or discovery and registration process. For example, in one or more embodiments, a push registration may involve an endpoint causing its information to be sent and registered with the CDC, and a pull registration may involve the CDC discovering and retrieving an endpoint's information. It shall be noted that a number of different discovery and registration processes may be utilized in embodiments herein.

Note that in the depicted embodiment, the fabric 105 may comprise a number of interconnected networking information handling system (e.g., switches and/or routers). For example, FIG. 1 shows, for sake of illustration of embodiments herein, that host A 115-A connects to the fabric 105 via switch U 125-u, and host x 115-x connects to the fabric 105 via switch V 125-V.

In one or more embodiments, the CDC may maintain one or more datastores of information related to the endpoints and their management. For example, zoning information may be defined in a nameserver (or zone) database (not depicted). For NVMe environments, zones may be maintained by the CDC. In one or more embodiments, a zone (which may also be referred to as a zone group) is a unit of activation (i.e., a set of access control rules enforceable by the CDC). Once in a zone, the interfaces of endpoints (which may be referred to as zone members) are able to communicate with one another when the zone has been added to an active zone set of the nameserver database. Zones may be created for a number of reasons, including to increase network security, and to prevent data loss or data corruption by controlling access between devices or user groups.

As discussed in more detail below, in one or more embodiments, a CDC may maintain a datastore of ports and corresponding operating speeds. It shall be noted that the datastore/database may be maintained centrally or distributed by the CDC and/or may comprise additional information.

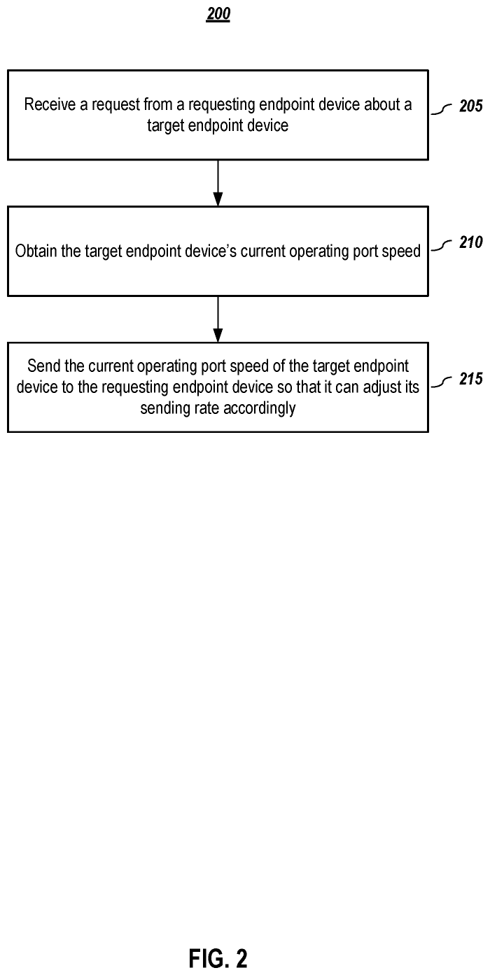

FIG. 2 depicts a general methodology for mitigating congestion by controlling port speed, according to embodiments of the present disclosure. In one or more embodiments, the CDC may receive (205) a request from a requesting endpoint device about a target endpoint device. For example, a host system or a storage array (which may be referred to as a “requesting endpoint” or “requesting system”) may make a request of the CDC to obtain port information about a corresponding endpoint device, which is remotely connected to the requesting system, which may be referred to as a “target system” or “target endpoint”. Upon receiving the request from the requesting system, the CDC may obtain (210) the target endpoint device's current operating port speed. As will be presented in more detail below, the process by which the CDC may obtain the target endpoint's operating port speed may vary, but in any event, upon obtain the target endpoint's operating port speed, the CDC may then send (215) the operating port speed of the target endpoint device to the requesting endpoint device so that it can adjust its sending rate accordingly (if needed). Note that the current operating port speed shall be understood to mean the current operating port speed as deemed by the system. For example, the current operating port speed may be the last obtained value, may be an average (mean, median, or mode) value from a set of values, may be a value set within a limit threshold, or using some other heuristic to set an “operating” value. Note that the device's port speed may have changed somewhat since it last obtained value but for purposes of one or more embodiments herein the valued deemed by a rule or set of rules (e.g., the last obtained value) shall be deemed to be the current operating port speed.

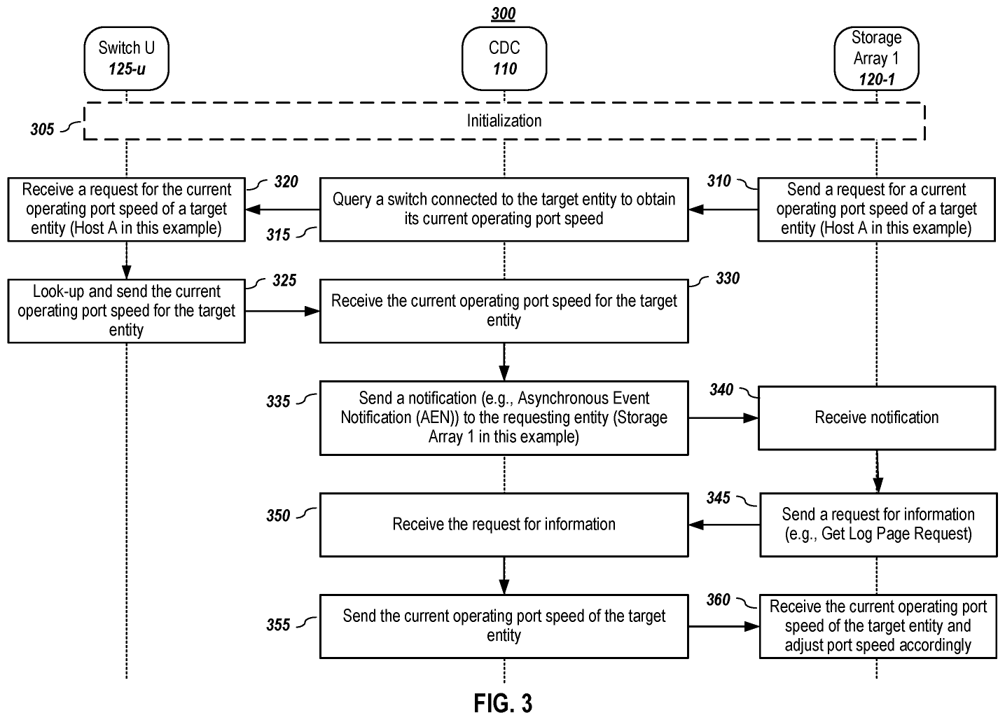

FIG. 3 depicts a methodology for mitigating congestion by controlling port speed, according to embodiments of the present disclosure. In the depicted embodiment, an initialization process is presumed to have occurred (305) (e.g., discovery and registration of endpoint systems such as the hosts and storage subsystems/storage arrays) so that they may interact with the CDC. The depicted embodiment of FIG. 3 may commence by a requesting endpoint (e.g., storage array 1 120-1 in this example) sending (310) a request for a current operating port speed of a target entity (i.e., host A in this example). In one or more embodiments, this request may be triggered by the storage array receiving a new connection request from a host (i.e., host A 115-A in this example).

The CDC 110 receives the request and queries (315) a networking information handling system (i.e., switch U 125-u in this example) connected to the target entity (i.e., host A) to obtain its current operating port speed. As part of a typical initial connection process between an endpoint (e.g., the host bus adapter of a host) and the networking information handling system (e.g., switch) to which the endpoint connects is to negotiate a port speed at which they will communicate. Thus, the CDC may obtain this information from the networking information handling system that connects to the target endpoint. In one or more embodiments, the CDC possesses an out-of-band connection to each switch (e.g., switch U 125-u, switch V 125-v) that is a part of the Ethernet fabric 105. The CDC 110 may use the out-of-band connection to retrieve an ARP (address resolution protocol) table from each of the switches. The ARP table may comprise IP (Internet Protocol) addresses and associated MAC (media access control) addresses and may be used to determine to which port on the switch the host (i.e., host A 115-A in this example) is attached. Furthermore, if a new host connects to a switch, the switch may send a notification (e.g., via SNMP (simple network management protocol)) to the CDC that allows the CDC to retrieve an updated ARP table. This information allows the CDC to determine which switch a host is connected to.

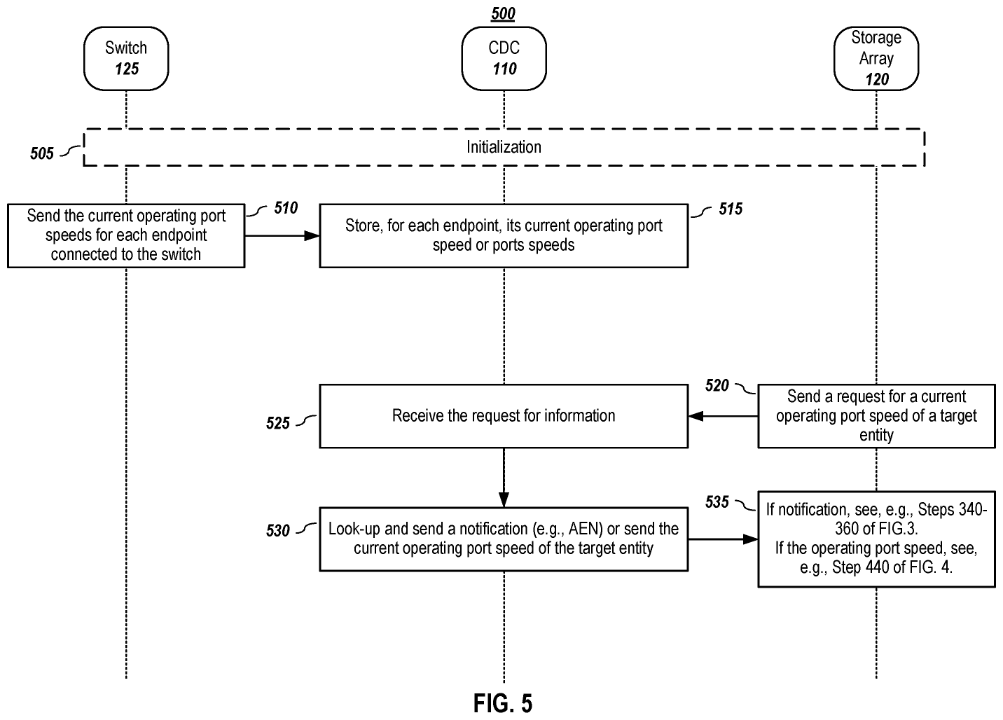

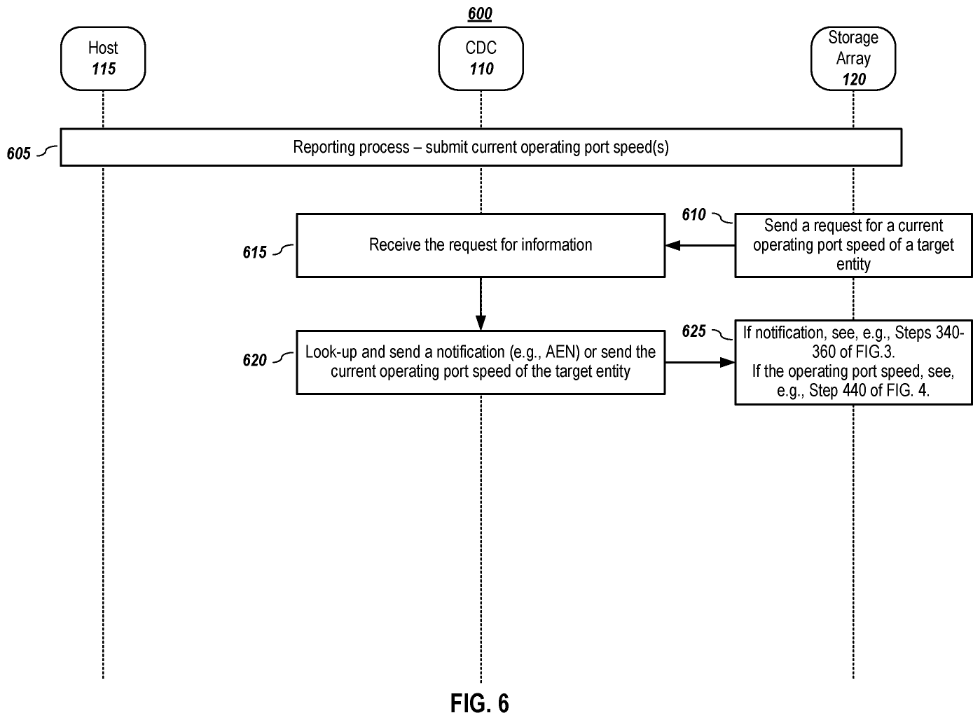

In one or more embodiments, the CDC may use an application programming interface (API), such as Redfish, to get the port speed of the switch. Redfish is an industry-standard REST API (Representational State Transfer Application Programming Interface), which is an architectural style for designing networked applications that different network equipment may use. Thus, the CDC may make a standard Redfish API call to the switch to obtain the speed or speeds of one or more of its ports. In one or more embodiments, this API call works across different manufacturers of switches (e.g., Cisco, Dell, Arista, Juniper, or other networking equipment providers). As described with respect to FIG. 5 and FIG. 6, the CDC may obtain the port speeds in different ways, such as from the networking information handling system (e.g., switch) as part of a discovery process, registration process, or initiation process (e.g., FIG. 5) or from the endpoint as part of a reporting process (e.g., FIG. 6). One skilled in the art shall recognize that the CDC may obtain the port speeds in other ways and may store them for obtaining when a request is made.

The networking information handling system (i.e., switch 125-u in this example) receives (320) the request for the current operating port speed of a target entity (i.e., host A in this example). In one or more embodiments, the switch looks-up the current negotiated port speed for the identified endpoint and sends (325) the operating port speed for the target entity (or target endpoint) back to the CDC.

In the depicted methodology shown in FIG. 3, the CDC 110 receives (330) the operating port speed for the target entity and sends (335) a notification (e.g., Asynchronous Event Notification (AEN)) to the requesting entity (i.e., storage array 1 120-1 in this example).

The requesting entity (i.e., storage array 1 120-1) receives (340) the notification from the CDC and sends (345) a request for information (e.g., issues a Get Log Page Request) to the CDC. The CDC receives (350) the request for information and responds by sending (355) the current operating port speed of the target entity to the requesting entity.

The requesting system (i.e., storage array 1 120-1) receives (360) the operating port speed of the target entity and adjusts (if necessary) its port speed accordingly. For example, in one or more embodiments, the requesting system uses the operating port speed of the target system divided by a number of port connections the requesting system has to the target system to set a port speed of its port for that target system. For example, if storage array 120-1 has two connections to the host bus adapter of host A 115-A, the storage array may be reduce the combined bandwidth usage (e.g., dividing the bandwidth usage of the prior port by 2) so that the host (or its host bus adapter (HBA)) does not get overwhelmed if the storage array can transmit faster than the host/HBA can receive. That is, because a host bus adapter of an endpoint may support multiple ports, the corresponding connected endpoint may monitor the overall bandwidth going to the connected ports of a same HBA of the host so that it does not become overwhelmed. Therefore, in one or more embodiments, if a single host port that has a maximum bandwidth capacity (e.g., 8 Gbps) accesses a single storage port that operates at a higher capability (e.g., 16 Gbps), then the storage subsystem may determine this mismatch (e.g., via one or more of the embodiments in this patent document) and may set a bandwidth limit for that host port on that storage port to 8 Gbps (i.e., the speed of the host port). In one or more embodiments, if a host was to access two storage ports, with each of them capable of running at 16 Gbps, the storage subsystem may, based upon the host's port speed (e.g., 8 Gbps), set a bandwidth limit for that host port on each of the storage ports to 4 Gbps (for a total of 8 Gbps).

It shall be noted that, in most instances, a host will be communicating or connecting with a single storage array/storage subsystem. However, one or more embodiments may include coordination between or across multiple storage arrays for the sake of adjusting port speeds. For example, since requests for port speeds are being channeled through the CDC, it may maintain a listing or datastore of hosts and their connections to storage arrays. Additionally, or alternatively, the CDC may adapt existing information it maintains, such as active zoning listings, to track a host's connections to storage arrays. In any event, the CDC may include in its response to a requesting endpoint the number of other endpoints that are also connected to the same target endpoint. Additionally, or alternatively, each time a new connection request is made involving the target endpoint and a different endpoint, the CDC may interact with the requesting endpoint to inform it that another connection has been made. The requesting endpoint may then use this information to adjust one or more port speeds related to the target endpoint.

In one or more embodiments, the requesting endpoint may also coordinate with the other third-party endpoint, directly or indirectly (e.g., via the CDC), port speeds based upon actual usage. For example, if a host is connected to two storage arrays, one storage array may only need to reduce its port speed if the second storage array is also concurrently transmitting to the host. If one of the two connections are not actively being used, that fact may be used as a factor when setting port speed. Thus, in one or more embodiments, one storage array may signal another storage array (either directly or via the CDC) that it is active transmitting or no longer actively transmitting to the common host, and vice versa.

It shall be noted that embodiments herein may be described in terms of the requesting endpoint as being a storage array/storage subsystem and the target endpoint as being a host. However, embodiments of the current disclosure are not limited so. Embodiments herein may be utilized or adapted for use with the requesting endpoint being the host system and the target endpoint being a storage array. Furthermore, one or more embodiments may involve a bi-directional/mutual implementation or bi-directional/mutual sharing of port speed information.

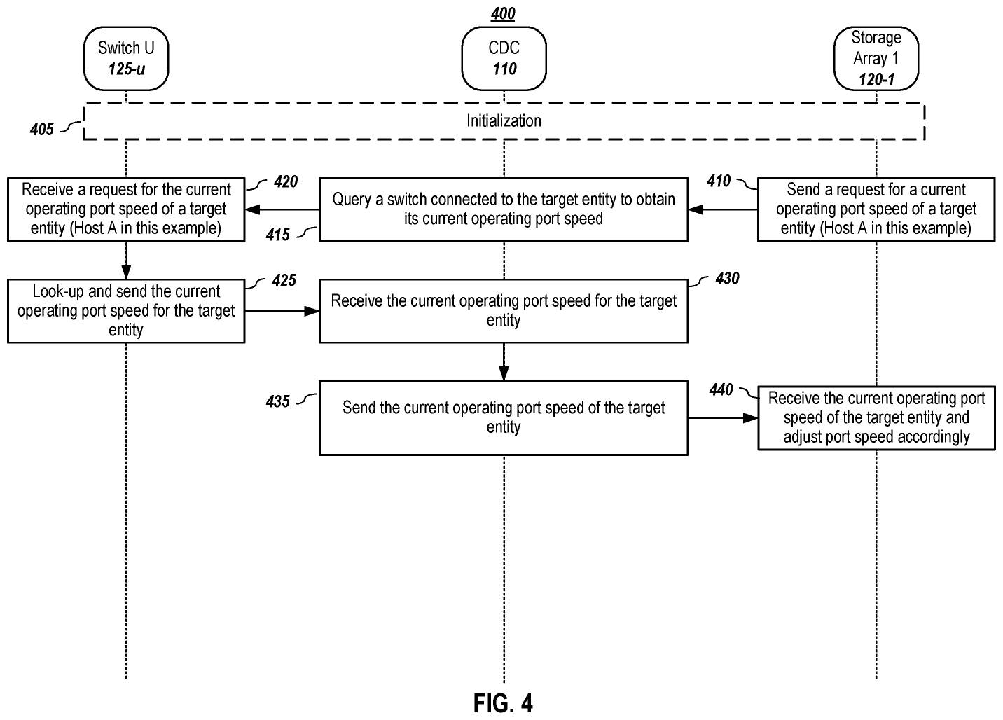

Turning next to FIG. 4, depicted is an alternative methodology for mitigating congestion by controlling port speed, according to embodiments of the present disclosure. In the depicted embodiment, an initialization process is presumed to have occurred (405) (e.g., discovery and registration of endpoint systems such as the hosts and storage subsystems/storage arrays) so that they are known to and may correspond with the CDC. The depicted embodiment of FIG. 4 may commence by a requesting endpoint (e.g., storage array 1 120-1 in this example) sending (410) a request for a current operating port speed of a target entity (i.e., host A 115-A in this example). In one or more embodiments, this request may be triggered by the storage array receiving a new connection request from a host (i.e., host A).

The CDC 110 receives the request and queries (415) a corresponding networking information handling system (i.e., switch U 125-u in this example) connected to the target entity (i.e., host A) to obtain the target endpoint's operating port speed. As noted above, port speed between the target endpoint and the networking information handling system has previously been negotiated and is known by the networking information handling system. Thus, the CDC may obtain this information from the networking information handling system that connects to the target endpoint. In one or more embodiments, the CDC may obtain this information using one or more of the methods discussed herein with (e.g., using an API, obtaining it from a datastore having previously obtained it from either the target endpoint, the networking information handling system, or another system).

The networking information handling system (i.e., switch 125-u) receives (420) the request for the current operating port speed of a target entity (i.e., host A). In one or more embodiments, the switch looks-up the current negotiated port speed for the identified endpoint and sends (425) the operating port speed for the target endpoint back to the CDC 110.

In the depicted methodology shown in FIG. 4, the CDC 110 receives (430) the operating port speed for the target entity and sends (435) the operating port speed of the target entity to the requesting entity. The requesting system (i.e., storage array 1 120-1) receives (440) the operating port speed of the target entity and adjusts (if necessary) its port speed accordingly. Note that FIG. 4 covers at least embodiments in which: (1) the initial request (step 410) may be (or may be treated as) a get log page request, and the response (step 435) is the response to that get log page request; or (2) that CDC is able to directly reply to the requesting endpoint without having to use an AEN-GLP Request-GLP Reply format of interchange between the CDC and the requesting endpoint.

As noted previously, the CDC may obtain the port speeds in different ways, such as those depicted in FIG. 5 and FIG. 6.

FIG. 5 depicts another alternative methodology for mitigating congestion by controlling port speed, according to embodiments of the present disclosure, in which the networking information handling system (e.g., switch 125 in this example) sends (510) the port speed or speeds of endpoints connected to it. The CDC receives this port speed information and may store (515), for each received endpoint, its port speed or speeds. Then, when a requesting system (e.g., storage array 120) makes a request for information, the CDC may obtain the information from its own datastore. In one or more embodiments, the CDC may update the port speed information via one or more of a push, pull, or both mechanisms.

FIG. 6 depicts yet another alternative methodology for mitigating congestion by controlling port speed, according to embodiments of the present disclosure, in which one or more of the endpoints report their port speeds. In one or more embodiments, an endpoint (e.g., a host 115 and/or storage array 120) may supply (605) its port speed(s) as part of a reporting process. The reporting process may be part of a discovery process, a registration process, an initiation process, or may be its own reporting process. When a requesting system (e.g., storage array 120) makes a request for information, the CDC may obtain the information from its own datastore. In one or more embodiments, the CDC may update the port speed information via one or more of a push, pull, or both mechanisms.

While not depicted in any figure, in other embodiments, the CDC may collect port speeds and distribute that information to one or more of the endpoints involved in a connection. For example, as part of the zoning process, the CDC may inform the zone members of port speeds of one or more of the other zone members. Alternatively, or additionally, it may be communicated as part of a connection request. One skilled in the art shall recognize other opportunities within operations of Ethernet SANs in which the port speed information may be collected and distributed.

### C. Information Handling System & Other Embodiments

In one or more embodiments, aspects of the present patent document may be directed to, may include, or may be implemented on one or more information handling systems (or computing systems). An information handling system/computing system may include any instrumentality or aggregate of instrumentalities operable to compute, calculate, determine, classify, process, transmit, receive, retrieve, originate, route, switch, store, display, communicate, manifest, detect, record, reproduce, handle, or utilize any form of information, intelligence, or data. For example, a computing system may be or may include a personal computer (e.g., laptop), tablet computer, mobile device (e.g., personal digital assistant (PDA), smart phone, phablet, tablet, etc.), smart watch, server (e.g., blade server or rack server), a network storage device, camera, or any other suitable device and may vary in size, shape, performance, functionality, and price. The computing system may include random access memory (RAM), one or more processing resources such as a central processing unit (CPU) or hardware or software control logic, read only memory (ROM), and/or other types of memory. Additional components of the computing system may include one or more drives (e.g., hard disk drives, solid state drive, or both), one or more network ports for communicating with external devices as well as various input and output (I/O) devices. The computing system may also include one or more buses operable to transmit communications between the various hardware components.

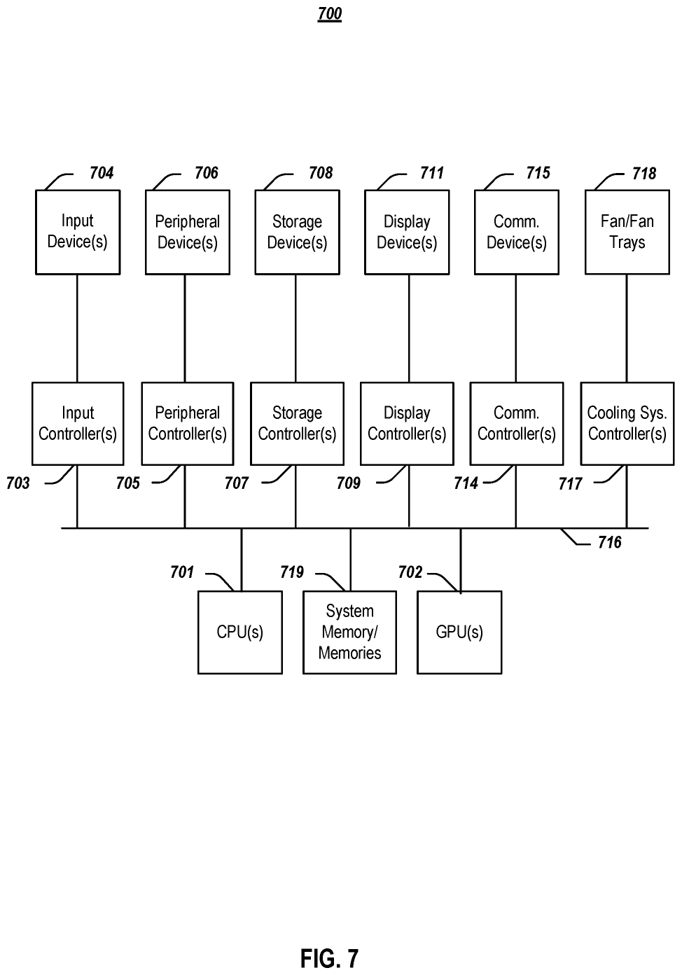

FIG. 7 depicts a simplified block diagram of an information handling system (or computing system), according to embodiments of the present disclosure. It will be understood that the functionalities shown for system 700 may operate to support various embodiments of a computing system—although it shall be understood that a computing system may be differently configured and include different components, including having fewer or more components as depicted in FIG. 7.

As illustrated in FIG. 7, the computing system 700 includes one or more CPUs 701 that provides computing resources and controls the computer. CPU 701 may be implemented with a microprocessor or the like and may also include one or more graphics processing units (GPU) 702 and/or a floating-point coprocessor for mathematical computations. In one or more embodiments, one or more GPUs 702 may be incorporated within the display controller 709, such as part of a graphics card or cards. The system 700 may also include a system memory 719, which may comprise RAM, ROM, or both.

A number of controllers and peripheral devices may also be provided, as shown in FIG. 7. An input controller 703 represents an interface to various input device(s) 704, such as a keyboard, mouse, touchscreen, stylus, microphone, camera, trackpad, display, etc. The computing system 700 may also include a storage controller 707 for interfacing with one or more storage devices 708 each of which includes a storage medium such as magnetic tape or disk, or an optical medium that might be used to record programs of instructions for operating systems, utilities, and applications, which may include embodiments of programs that implement various aspects of the present disclosure. Storage device(s) 708 may also be used to store processed data or data to be processed in accordance with the disclosure. The system 700 may also include a display controller 709 for providing an interface to a display device 711, which may be a cathode ray tube (CRT) display, a thin film transistor (TFT) display, organic light-emitting diode, electroluminescent panel, plasma panel, or any other type of display. The computing system 700 may also include one or more peripheral controllers or interfaces 705 for one or more peripherals 706. Examples of peripherals may include one or more printers, scanners, input devices, output devices, sensors, and the like. A communications controller 714 may interface with one or more communication devices 715, which enables the system 700 to connect to remote devices through any of a variety of networks including the Internet, a cloud resource (e.g., an Ethernet cloud, a Fibre Channel over Ethernet (FCOE)/Data Center Bridging (DCB) cloud, etc.), a local area network (LAN), a wide area network (WAN), a storage area network (SAN) or through any suitable electromagnetic carrier signals including infrared signals. As shown in the depicted embodiment, the computing system 700 comprises one or more fans or fan trays 718 and a cooling subsystem controller or controllers 717 that monitors thermal temperature(s) of the system 700 (or components thereof) and operates the fans/fan trays 718 to help regulate the temperature.

In the illustrated system, all major system components may connect to a bus 716, which may represent more than one physical bus. However, various system components may or may not be in physical proximity to one another. For example, input data and/or output data may be remotely transmitted from one physical location to another. In addition, programs that implement various aspects of the disclosure may be accessed from a remote location (e.g., a server) over a network. Such data and/or programs may be conveyed through any of a variety of machine-readable media including, for example: magnetic media such as hard disks, floppy disks, and magnetic tape; optical media such as compact discs (CDs) and holographic devices; magneto-optical media; and hardware devices that are specially configured to store or to store and execute program code, such as application specific integrated circuits (ASICs), programmable logic devices (PLDs), flash memory devices, other nonvolatile memory (NVM) devices (such as 3D XPoint-based devices), and ROM and RAM devices.

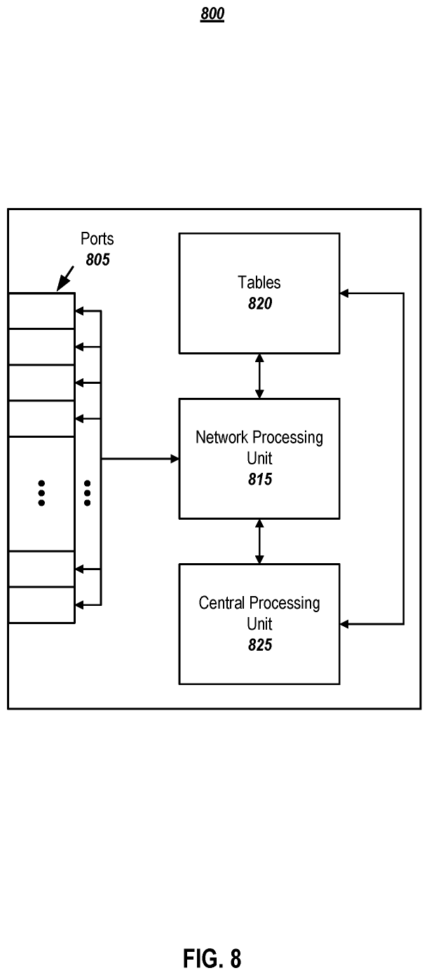

FIG. 8 depicts an alternative block diagram of an information handling system, according to embodiments of the present disclosure. It will be understood that the functionalities shown for system 800 may operate to support various embodiments of the present disclosure—although it shall be understood that such system may be differently configured and include different components, additional components, or fewer components.

The information handling system 800 may include a plurality of I/O ports 805, a network processing unit (NPU) 815, one or more tables 820, and a CPU 825. The system includes a power supply (not shown) and may also include other components, which are not shown for sake of simplicity.

In one or more embodiments, the I/O ports 805 may be connected via one or more cables to one or more other network devices or clients. The network processing unit 815 may use information included in the network data received at the node 800, as well as information stored in the tables 820, to identify a next device for the network data, among other possible activities. In one or more embodiments, a switching fabric may then schedule the network data for propagation through the node to an egress port for transmission to the next destination.

Aspects of the present disclosure may be encoded upon one or more non-transitory computer-readable media comprising one or more sequences of instructions, which, when executed by one or more processors or processing units, causes steps to be performed. It shall be noted that the one or more non-transitory computer-readable media shall include volatile and/or nonvolatile memory. It shall be noted that alternative implementations are possible, including a hardware implementation or a software/hardware implementation. Hardware-implemented functions may be realized using ASIC(s), programmable arrays, digital signal processing circuitry, or the like. Accordingly, the “means” terms in any claims are intended to cover both software and hardware implementations. Similarly, the term “computer-readable medium or media” as used herein includes software and/or hardware having a program of instructions embodied thereon, or a combination thereof. With these implementation alternatives in mind, it is to be understood that the figures and accompanying description provide the functional information one skilled in the art would require to write program code (i.e., software) and/or to fabricate circuits (i.e., hardware) to perform the processing required.

It shall be noted that embodiments of the present disclosure may further relate to computer products with a non-transitory, tangible computer-readable medium that has computer code thereon for performing various computer-implemented operations. The media and computer code may be those specially designed and constructed for the purposes of the present disclosure, or they may be of the kind known or available to those having skill in the relevant arts. Examples of tangible computer-readable media include, for example: magnetic media such as hard disks, floppy disks, and magnetic tape; optical media such as compact discs (CDs) and holographic devices; magneto-optical media; and hardware devices that are specially configured to store or to store and execute program code, such as ASICs, PLDs, flash memory devices, other nonvolatile memory devices (such as 3D XPoint-based devices), ROM, and RAM devices. Examples of computer code include machine code, such as produced by a compiler, and files containing higher level code that are executed by a computer using an interpreter. Embodiments of the present disclosure may be implemented in whole or in part as machine-executable instructions that may be in program modules that are executed by a processing device. Examples of program modules include libraries, programs, routines, objects, components, and data structures. In distributed computing environments, program modules may be physically located in settings that are local, remote, or both.

One skilled in the art will recognize no computing system or programming language is critical to the practice of the present disclosure. One skilled in the art will also recognize that a number of the elements described above may be physically and/or functionally separated into modules and/or sub-modules or combined together.

It will be appreciated to those skilled in the art that the preceding examples and embodiments are exemplary and not limiting to the scope of the present disclosure. It is intended that all permutations, enhancements, equivalents, combinations, and improvements thereto that are apparent to those skilled in the art upon a reading of the specification and a study of the drawings are included within the true spirit and scope of the present disclosure. It shall also be noted that elements of any claims may be arranged differently including having multiple dependencies, configurations, and combinations.

What is claimed is:

1. A processor-implemented method comprising:
receiving, at a centralized discovery controller (CDC) of an Ethernet storage area network (SAN), a request from a requesting system to obtain an operating port speed of a target system;
obtaining, by the CDC, the operating port speed of the target system; and
sending the operating port speed of the target system to the requesting system via a response to the request.

2. The processor-implemented method of claim 1 wherein the requesting system is a nonvolatile-memory express (NVMe) storage subsystem and the target system is a host system.

3. The processor-implemented method of claim 1 wherein the step of sending the operating port speed of the target system to the requesting system via a response to the request comprises:
sending a notification to the requesting system indicating that the CDC has information for the requesting system;
receiving the request from the requesting system in response to the requesting system receiving the notification; and
sending the operating port speed of the target system to the requesting system in the response.

4. The processor-implemented method of claim 3 wherein:
the notification from the CDC is an asynchronous event notification;
the request from the requesting system is a get log page request; and
the response is a response to the get log page request.

5. The processor-implemented method of claim 1 wherein the requesting system uses the operating port speed of the target system divided by a number of port connections the requesting system has to the target system to set a port speed of its port for that target system.

6. The processor-implemented method of claim 1 wherein the step of obtaining the operating port speed of the target system comprises:
obtaining the operating port speed of the target system from a datastore accessible by the CDC, in which the operating port speed of the target system was obtained using at least one of the following methods:
obtaining the operating port speed of the target system from the target system as part of a registration process with the CDC and storing the operating port speed of the target system in the datastore; and
obtaining the operating port speed of the target system from a network information handling system that is connected to the target system.

7. The processor-implemented method of claim 6 wherein the step of obtaining the operating port speed of the target system from the network information handling system that is connected to the target system comprises:
obtaining the operating port speed of the target system from the network information handling system in response to the request from the requesting system.

8. The processor-implemented method of claim 6 wherein the step of obtaining the operating port speed of the target system from the network information handling system that is connected to the target system comprises:
obtaining the operating port speed of the target system from the network information handling system prior to the CDC receiving the request from the requesting system.

9. A processor-implemented method for handling congesting in an Ethernet storage area network (SAN), the method comprising:
receiving, at a centralized discovery controller (CDC) of the Ethernet SAN, a request from a requesting endpoint of the Ethernet SAN to obtain an operating port speed of a target endpoint of the Ethernet SAN;
obtaining an operating port speed of the target endpoint; and
sending the operating port speed of the target endpoint to the requesting endpoint.

10. The processor-implemented method of claim 9 wherein the requesting endpoint is a nonvolatile-memory express (NVMe) storage subsystem and the target endpoint is a host system.

11. The processor-implemented method of claim 9 wherein the step of sending the operating port speed of the target endpoint to the requesting endpoint comprises:
sending a notification to the requesting endpoint that the CDC has information for the requesting endpoint;
receiving an information request from the requesting endpoint; and
sending the operating port speed of the target endpoint to the requesting endpoint in a response to the information request.

12. The processor-implemented method of claim 9 wherein the requesting endpoint uses the operating port speed of the target endpoint divided by a number of port connections the requesting endpoint has to the target endpoint to set a port speed of its port connection to that target endpoint.

13. The processor-implemented method of claim 9 wherein the step of obtaining the operating port speed of the target endpoint comprises:
obtaining from a networking information handling system connected to the target endpoint the operating port speed of the target endpoint.

14. The processor-implemented method of claim 9 wherein the step of obtaining the operating port speed of the target endpoint comprises:
obtaining the operating port speed of the target endpoint from the target endpoint as part of an initial registration process with the CDC.

15. The processor-implemented method of claim 9 wherein the request from the requesting endpoint of the Ethernet SAN to obtain the operating port speed of the target endpoint was sent according to a schedule.

16. An information handling system, which provides at least some services of a centralized discovery controller (CDC) of an Ethernet storage area network (SAN), the information handling system comprising:
one or more processors; and
a non-transitory computer-readable medium or media comprising one or more sets of instructions which, when executed by at least one of the one or more processors, causes steps to be performed comprising:
receiving a request from a requesting endpoint of the Ethernet SAN to obtain an operating port speed of a target endpoint of the Ethernet SAN;
obtaining an operating port speed of the target endpoint; and
sending the operating port speed of the target endpoint to the requesting endpoint.

17. The information handling system of claim 16 wherein:
the requesting endpoint is a nonvolatile-memory express (NVMe) storage subsystem; and
the target endpoint is a host system.

18. The information handling system of claim 16 wherein the step of sending the operating port speed of the target endpoint to the requesting endpoint comprises:
sending a notification to the requesting endpoint that the CDC has information for the requesting endpoint;
receiving an information request from the requesting endpoint; and
sending the operating port speed of the target endpoint to the requesting endpoint in a response to the information request.

19. The information handling system of claim 16 wherein the requesting endpoint uses the operating port speed of the target endpoint divided by a number of port connections the requesting endpoint has to the target endpoint to set a port speed of its port connection to that target endpoint.

20. The information handling system of claim 16 wherein the step of obtaining the operating port speed of the target endpoint comprises:
obtaining the operating port speed of the target endpoint from a datastore accessible by the CDC, in which the operating port speed of the target endpoint was obtained using at least one of the following methods:
obtaining the operating port speed of the target endpoint from the target endpoint as part of a registration process with the CDC and storing the operating port speed of the target endpoint in the datastore; and
obtaining the operating port speed of the target endpoint from a network information handling system that is connected to the target endpoint.
